(19) United States
(12) Patent Application Publication
(10) Pub. No.: US 2010/0079350 A1
(43) Pub. Date: Apr. 1, 2010

(54) WWAN PRINTED CIRCUIT ANTENNA WITH THREE MONOPOLE ANTENNAS DISPOSED ON A SAME PLANE

(76) Inventors: Ming-Iu Lai, Taipei (TW); Wei-Sheng Chang, Taipei (TW)

Correspondence Address: Dr. BANGER SHIA, 102 Lindencrest Ct., Sugar Land, TX, 77479-5201, US

(21) Appl. No.: 12/545,436

(22) Filed: Aug. 21, 2009

(30) Foreign Application Priority Data
Sep. 26, 2008 (TW) 97137055

(51) Int. Cl. H01Q 5/00; H01Q 21/00; H01Q 1/38

(52) U.S. Cl. 343/843; 343/893; 343/700 MS

(57) ABSTRACT

A WWAN printed circuit antenna includes three monopole antennas in the printed circuit board. Signals are fed in from the feed monopole antenna. The first and second radiating monopole antennas are actuated by the feed monopole antenna in an electromagnetic coupling way. Therefore, a three-dimensional structure derived from the planar inverted-F antenna can be replaced, and the limitation of space usage can be overcome.

### BACKGROUND OF THE INVENTION

1. Field of Invention

The invention relates to a WWAN printed circuit antenna and, more particularly, to a WWAN printed circuit antenna using three monopole antennas disposed on a same plane.

2. Related Art

Wireless wide area network (WWAN) is a wireless network whose transmission range may cross different cities or different countries. Since the range is large, a special service provider is usually needed to establish and maintain the entire network. Common people just use the WWAN by a terminal connection device. For example, global system for mobile communications (GSM) which most mobile phones use presently belongs to a kind of the WWAN. Consequently, via connections made by GSM operators, a high-speed data transfer rate can be provided, extensive data services including high-speed Internet access, large files downloading, streaming audio and video can be supported.

Consequently, all conventional portable electronic devices are extensively set with antenna systems which support the WWAN. Generally speaking, all the most common antennas are the changes based on a planar inverted-F antenna. However, to obtain better transmission efficiency, the structure changes of antennas usually refer to fine adjustments toward three-dimensional structures, and the manufacture is complicated. Meanwhile, a height of a common antenna is between 3 mm and 5 mm. To the electronic devices becoming more and more miniaturized, an exterior design is usually rather limited, and particularly to small-size notebook computers, the situation is more serious.

### SUMMARY OF THE INVENTION

The invention discloses a WWAN printed circuit antenna. The WWAN printed circuit antenna includes a printed circuit board, a feeding monopole antenna, a first radiating monopole antenna, and a second radiating monopole antenna. The printed circuit board has a first surface and a second surface opposite to the first surface. The feeding monopole antenna, the first radiating monopole antenna, and the second radiating monopole antenna are disposed on a same surface. The first radiating monopole antenna, the second radiating monopole antenna, and the feeding monopole antenna are unconnected with each other. The feeding monopole antenna is used to excite the first radiating monopole antenna and the second radiating monopole antenna in an electromagnetic coupling way.

The length of the feeding monopole antenna is shorter than the length of the second radiating monopole antenna. The length of the second radiating monopole antenna is shorter than the length of the first radiating monopole antenna. More preferably, the first radiating monopole antenna operates at around 900 MHz, the second radiating monopole antenna operates at about 1700 MHz, and the feeding monopole antenna operates at about 1950-2050 MHz. As a result, an operation bandwidth of the entire printed circuit antenna is 880 to 960 MHz and 1710 to 2170 MHz.

These and other features, aspects and advantages of the present invention will become better understood with regard to the following description, appended claims, and accompanying drawings.

### BRIEF DESCRIPTION OF THE DRAWINGS

FIG. 1A and FIG. 1B are schematic diagrams showing a WWAN printed circuit antenna according to an embodiment of the invention;

FIG. 2 is a schematic diagram showing a WWAN printed circuit antenna according to another embodiment of the invention;

FIG. 3 is an analogous schematic diagram showing a reflection coefficient of a WWAN printed circuit antenna according to an embodiment of the invention; and

FIG. 4A and FIG. 4B are measurement schematic diagrams showing a reflection coefficient of a WWAN printed circuit antenna after adjustments and checks according to the invention.

### DETAILED DESCRIPTION OF THE INVENTION

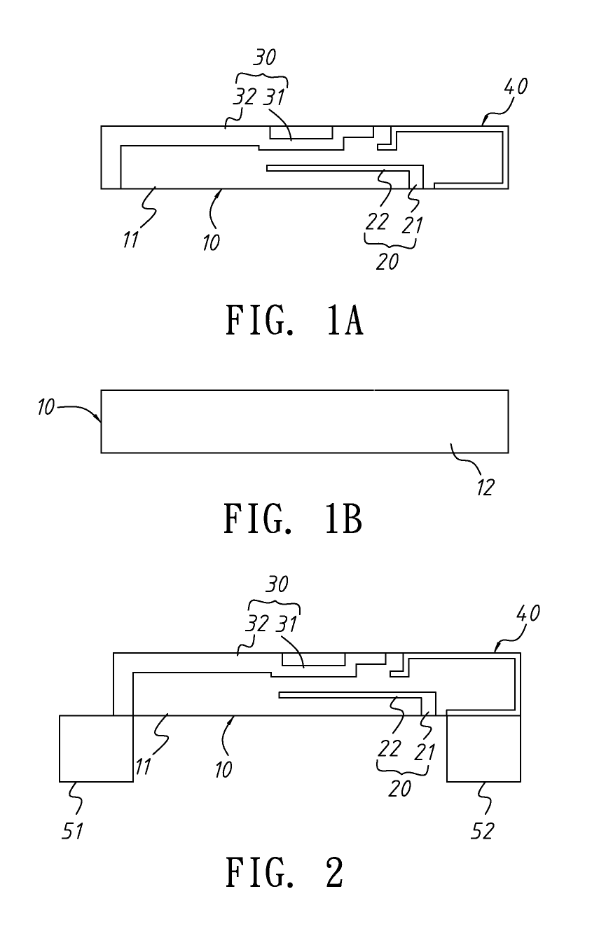

FIG. 1A and FIG. 1B are schematic diagrams showing a WWAN printed circuit antenna according to an embodiment of the invention.

A WWAN printed circuit antenna according to an embodiment of the invention includes a printed circuit board 10, a feeding monopole antenna 20, a first radiating monopole antenna 30, and a second radiating monopole antenna 40. The printed circuit board 10 includes a first surface 11 (shown in FIG. 1A) and a second surface 12 (shown in FIG. 1B) opposite to the first surface 11. In other words, the first surface 11 and the second surface 12 are two layout side surfaces of the printed circuit board 10.

The feeding monopole antenna 20, the first radiating monopole antenna 30, and the second radiating monopole antenna 40 are all disposed on a same side surface of the printed circuit board 10. In FIG. 1B, the feeding monopole antenna 20, the first radiating monopole antenna 30, and the second radiating monopole antenna 40 are all disposed on the first surface 11 of the printed circuit board 10. The feeding monopole antenna 20, the first radiating monopole antenna 30, and the second radiating monopole antenna 40 are not connected with each other.

The feeding monopole antenna 20 is a conductive trace disposed on the first surface 11 of the printed circuit board 10, and it includes a feeding line 21 and a coupling line 22 connected with the feeding line 21 used for receiving a signal source. The coupling line 22 excites the first radiating monopole antenna 30 and the second radiating monopole antenna 40. Consequently, the coupling line 22 is approximately slender. The length of the coupling line 22 is larger than that of the feed line 21. However, the width of the coupling line 22 is narrower than that of the feeding line 21.

The first radiating monopole antenna 30 is a conductive trace disposed on the first surface 11 of the printed circuit board 10. The first radiating monopole antenna 30 includes a front part 31 and a back part 32. The width of the front part 31 is narrower than that of the back part 32. The front part 31 of the first radiating monopole antenna 30 is closer to the coupling line 22 of the feeding monopole antenna 20 to obtain a better electromagnetic coupling effect. On the whole, to make the volume of the printed circuit board 10 smaller, the first radiating monopole antenna 30 is disposed on a left side or a top left side of the first surface 11 of the printed circuit board 10, and thus its length can reach a certain value, and the length of the printed circuit board 10 does not need to be too long. The length of the first radiating monopole antenna 30 is about a quarter of a wavelength of the first bandwidth over which the first radiating monopole antenna 30 operates.

The second radiating monopole antenna 40 is a conductive trace disposed on the first surface 11 of the printed circuit board 10. Similarly, to make the volume of the printed circuit board 10 smaller, the second radiating monopole antenna 30 is disposed on a right side or a top right side of the first surface 11 of the printed circuit board 10, and thus its length can reach a certain value, and the length of the printed circuit board 10 does not need to be too long. The length of the second radiating monopole antenna 40 is about a quarter of a wavelength of the second bandwidth over which the second radiating monopole antenna 40 operates.

FIG. 2 is a schematic diagram showing a WWAN printed circuit antenna according to another embodiment of the invention.

When a WWAN printed circuit antenna is used in an electronic device, the first radiating monopole antenna 30 and the second radiating monopole antenna 40 are connected to ground. As a result, the first radiating monopole antenna 30 and the second radiating monopole antenna 40 are connected to a first copper foil 51 and a second copper foil 52, respectively. The first copper foil 51 and the second copper foil 52 not only can be soldered to the electronic devices (not shown), but also are connected to a ground layer of the electronic device. Thus the first radiating monopole antenna 30 and the second radiating monopole antenna 40 are connected to ground.

On the other hand, the first radiating monopole antenna 30 operates over a bandwidth between 880 MHz and 960 MHz. The second radiating monopole antenna 40 opeartes over a bandwidth between 1700 MHz to 2000 MHz. The coupling line 22 of the feeding monopole antenna 20 operates over a bandwidth about 1950-2050 MHz. Thus, the operation bandwidth of the entire printed circuit antenna is 880 MHz to 960 MHz and 1710 MHz to 2170 MHz.

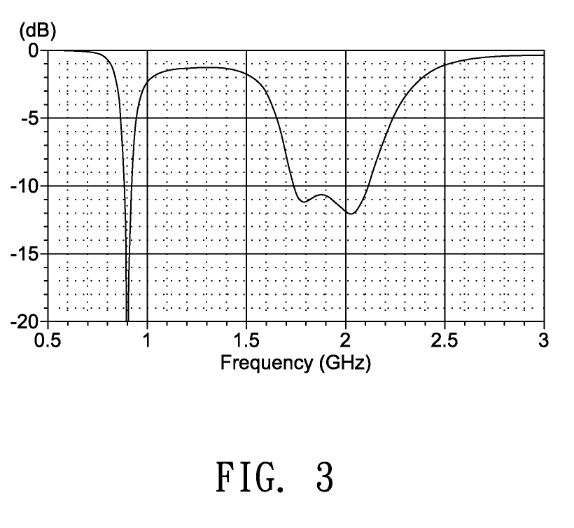

FIG. 3 is an analogous schematic diagram showing the simulated reflection coefficient of a WWAN printed circuit antenna according to an embodiment of the invention.

FIG. 3 is an analog diagram according to a structure of the printed circuit antenna in FIG. 2. In FIG. 3, there are two operation bandwidths which are a high-frequency bandwidth (1710-2170 MHz) and a low-frequency (880-960 MHz) bandwidth. According to a fundamental principle of the monopole antenna, the length of the monopole antenna is approximately a quarter of the wavelength. Consequently, the length of the coupling line 22 of the feeding monopole antenna 20 is shorter than that of the second radiating monopole antenna 40. Furthermore, the length of the second radiating monopole antenna 40 is shorter than that of the first radiating monopole antenna 30.

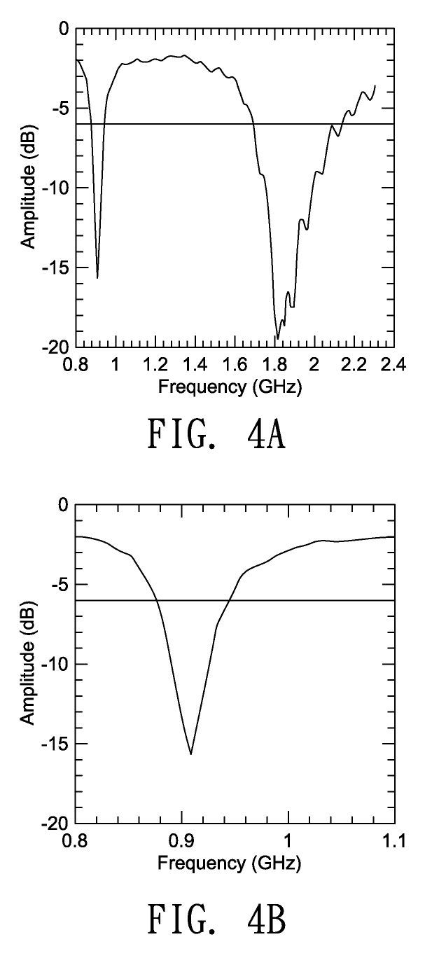

FIG. 4A and FIG. 4B are measurement schematic diagrams showing reflection coefficients of a WWAN printed circuit antenna after adjustments and checks according to the invention.

Better reflection coefficients can be obtained via adjusting a variety of relevant data and conditions of the feeding monopole antenna 20, the first radiating monopole antenna 30, and the second radiating monopole antenna 40. For example, it can be achieved by making the width of the coupling line 22 of the feeding monopole antenna 20 narrower than that of the second radiating monopole antenna 40, making the width of the second radiating monopole antenna 40 narrower than that of the first radiating monopole antenna 30, adjusting the width of the coupling line 22 to a half of that of the second radiating monopole antenna 40, adjusting the width of the front part 31 of the first radiating monopole antenna 30 to twice of that of the second radiating monopole antenna 40, and adjusting the width of the back part 32 of the first radiating monopole antenna 30 to more than a triple of that of the second radiating monopole antenna 40, or adjusting other relationships and distances between other lines.

The comparison table showing practical measurement data of the printed circuit antenna according to the invention and radiation efficiencies of three common planar inverted-F antennas with conventional three-dimensional structures is as follows:

TABLE 1

| Frequency | The | | | |
|---|---|---|---|---|
| (MHz) | invention | Pattern 1 | Pattern 2 | Pattern 3 |
| 880 | 44.8 | 39.6 | 52.7 | 54.9 |
| 897 | 55.7 | 43.5 | 49.0 | 57.8 |
| 914 | 53.0 | 44.1 | 42.4 | 52.3 |
| 925 | 51.7 | 44.7 | 40.0 | 50.4 |
| 942 | 41.8 | 38.4 | 32.3 | 40.3 |
| 959 | 33.8 | 31.2 | 26.3 | 31.8 |
| 1710 | 60.3 | 41.8 | 48.6 | 47.6 |
| 1747 | 63.4 | 41.3 | 49.1 | 52.7 |
| 1784 | 68.8 | 44.2 | 48.4 | 54.6 |
| 1805 | 68.9 | 45.1 | 47.4 | 54.8 |
| 1842 | 65.7 | 48.1 | 45.8 | 50.9 |
| 1879 | 61.7 | 46.6 | 44.7 | 48.2 |
| 1922 | 58.6 | 43.3 | 45.2 | 48.5 |
| 1950 | 59.4 | 42.2 | 45.9 | 49.3 |
| 1977 | 54.6 | 42.4 | 44.6 | 48.9 |
| 2112 | 44.1 | 33.7 | 33.4 | 36.6 |
| 2140 | 41.3 | 32.6 | 32.0 | 34.8 |
| 2167 | 37.5 | 31.5 | 30.7 | 32.3 |

Obviously, the efficiency of the printed circuit antenna according to the invention is obviously better than that of the planar inverted-F antennas with the conventional three-dimensional structures.

Consequently, the WWAN printed circuit antenna according to the invention utilizes three monopole antennas disposed on the printed circuit board to feed and radiate signals, respectively, and it actuates the antenna to radiate signals via the uncontacted electromagnetic coupling way. As a result, not only the efficiency can be improved greatly, but also a disadvantage that the planar inverted-F antennas with the conventional three-dimensional structures utilize the space poorly also can be overcome.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A WWAN printed circuit antenna, used for operating over a first bandwidth and a second bandwidth, wherein the second bandwidth is wider than the first bandwidth, comprising:
a printed circuit board having a first surface and a second surface opposite to the first surface;
a feed monopole antenna, disposed on the first surface, for receiving a signal;
a first radiating monopole antenna disposed on the first surface, connected with a ground terminal without connecting with the feed monopole antenna, wherein the length of the first radiating monopole antenna is corresponding to the first bandwidth, and the first radiating monopole antenna is actuated by the feed monopole antenna in an electromagnetic coupling way to operate over the first bandwidth; and
a second radiating monopole antenna disposed on the first surface, connected with another ground terminal without connecting with the feed monopole antenna and the first radiating monopole antenna, wherein the length of the second radiating monopole antenna is corresponding to the second bandwidth, and the second radiating monopole antenna is actuated by the feed monopole antenna in an electromagnetic coupling way to operate over the second bandwidth.

2. The WWAN printed circuit antenna according to claim 1, wherein the feed monopole antenna comprises a feed line and a coupling line connected with the feed line.

3. The WWAN printed circuit antenna according to claim 2, wherein the width of the coupling line is narrower than the width of the first radiating monopole antenna and the width of the second radiating monopole antenna.

4. The WWAN printed circuit antenna according to claim 2, wherein the length of the coupling line is shorter than the length of the first radiating monopole antenna and the length of the second radiating monopole antenna.

5. The WWAN printed circuit antenna according to claim 2, wherein the coupling line is operated over a third bandwidth to radiate, and the third bandwidth is wider than the first bandwidth and the second bandwidth.

6. The WWAN printed circuit antenna according to claim 5, wherein the third bandwidth is 1950-2050 MHz.

7. The WWAN printed circuit antenna according to claim 1, wherein the width of the first radiating monopole antenna is narrower than the width of the second radiating monopole antenna.

8. The WWAN printed circuit antenna according to claim 1, wherein the length of the first radiating monopole antenna is shorter than the length of the second radiating monopole antenna.

9. The WWAN printed circuit antenna according to claim 1, wherein the length of the first radiating monopole antenna is corresponding to a quarter of a wavelength of the first bandwidth.

10. The WWAN printed circuit antenna according to claim 1, wherein the length of the second radiating monopole antenna is corresponding to a quarter of a wavelength of the second bandwidth.

11. The WWAN printed circuit antenna according to claim 1, wherein the first radiating monopole antenna operates at 880 MHz to 960 MHz.

12. The WWAN printed circuit antenna according to claim 1, wherein the second radiating monopole antennas operates at 1700 MHz to 2000 MHz.
